(19) United States
(12) Patent Application Publication
(10) Pub. No.: US 2005/0273606 A1
(43) Pub. Date: Dec. 8, 2005

(54) Communication system, communication apparatus, operation control method, and program

(75) Inventor: Masayuki Ueda, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/141,317

(22) Filed: Jun. 1, 2005

(30) Foreign Application Priority Data
Jun. 2, 2004 (JP) 2004-163928

(51) Int. Cl. H04L 9/00

(52) U.S. Cl. 713/168

(57) ABSTRACT

A server previously includes an IPsec SA entry having information recorded therein, the information making it possible to determine whether or not data to be transmitted and received passes through IPsec SA between routers. The server monitors traffics on the IPsec SA and deletes the IPsec SA when no traffic exists for a prescribed period.

This application claims priority to prior Japanese patent application JP2004-163928, the disclosure of which is incorporated herein by reference.

### BACKGROUND OF THE INVENTION

The present invention relates to a communication system, a communication apparatus, an operation control method thereof, and a program, and more specifically, to a communication system for performing a communication between first and second communication nodes disposed on a communication network by establishing SA (security association) as a logical connection between the first and second communication nodes.

IPsec (Security Architecture for Internet Protocol) is used as a protocol for assuring security on IP (Internet Protocol). To perform communication using the IPsec, a logical connection called SA (Security Association) must be constructed between both the nodes for performing the communication so that both the nodes share information such as a key, algorism, and the like.

IPsec SA has an effective period (existing period) set thereto, and when the effective period of the SA nearly expires, new SA is created and replaced with old SA regardless that a traffic occurs between nodes in which the IPsec SA is established. That is, even if there is no traffic flowing on IPsec SA between two nodes, the IPsec SA continues to exist. The more the number of SAs is, the more the memory of IPsec terminal nodes consume and the longer time is necessary to search the SAs, thereby a resource use efficiency and a processing efficiency are deteriorated.

In contrast, RFC 3706, A “Traffic-Based Method of Detecting Dead Internet Key Exchange (IKE) Peers”, Chapters 5.4 and 5.5 (February, 2004) discloses a technology that when there is no traffic on IPsec SA between IPsec terminal nodes for a prescribed period, it is determined whether or not nodes exist between the terminal nodes, and when it cannot be confirmed that the nodes exist, the SA is deleted and new SA is created.

Although the IPsec terminal nodes manage SA, they must additionally determine whether or not the SA is to be deleted in the conventional technology described above, which increases the load of the terminal nodes.

Further, in the conventional technology, even if no traffic occurs for the prescribed period, when the existence of the nodes is confirmed, SA in which no traffic occurs is also maintained, thereby the resource use efficiency and the processing efficiency are deteriorated in the IPsec terminal nodes.

An object of the present invention is to provide a communication system, a communication apparatus, an operation control method thereof, and a program capable of reducing the load of communication nodes to which SA (Security Association) is established.

### SUMMARY OF THE INVENTION

According to the present invention, in a communication node apparatus disposed on a communication network including first and second communication nodes for performing communication through SA (Security Association) established as a logical connection between the first and second communication nodes, the load of the communication nodes in which the SA is established can be reduced by determining whether or not the SA is to be deleted based on the amount of traffics on the communication nodes.

A first aspect of the present invention, a system for performing communication between first and second nodes disposed on a communication network by establishing SA (Security Association) as a logical connection therebetween is provided. The system includes a third node for performing communication with an opponent node through the SA disposed on the communication network, wherein the third node determines according to the amount of traffics on the SA whether or not the SA is to be deleted.

When no traffic exists on the SA for a predetermined time, the third node may transmit a message for requesting to delete the SA to at least one of the first and second nodes.

The third node may previously stores information including the destination addresses and transmission source addresses of data to be transmitted through the SA and determine according to the information whether or not data that the third node sends/receives pass through the SA.

A second aspect of the invention, a communication node apparatus disposed on a communication network including first and second nodes for performing communication through SA (Security Association) established as a logical connection between the first and second nodes is provided. The apparatus determines according to the amount of traffics on the SA whether or not the SA is to be deleted.

A third aspect of the invention, an operation control method of a communication node apparatus disposed on a communication network including first and second nodes for performing communication through SA (Security Association) established as a logical connection between the first and second nodes is provided. The method includes the step of determining by the apparatus according to the amount of traffics on the SA whether or not the SA is to be deleted.

A fourth aspect of the invention, a program for causing a computer to perform the operation control method is provided.

Further, a fifth aspect of the invention, a communication node apparatus for performing communication by establishing an SA (Security Association) as a logical connection with a first node is provided. The apparatus deletes the SA when receiving a signal from a second node different from the first node. The second node generates the signal according to the amount of traffics on the SA. It is noted that the naming of nodes/apparatus in this aspect is different from those of the remaining aspects. The communication node apparatus and first node of the fifth aspect correspond to the first and second nodes of the first aspect. The second node of the fifth aspect corresponds to the third node of the first aspect.

### BRIEF DESCRIPTION OF THE DRAWINGS:

FIG. 1 is a view showing the arrangement of a remote access system in an IP network according to an embodiment of the present invention;

FIG. 2 is a view showing a transition example of an IP packet arrangement when IPsec communication is performed in the system shown in FIG. 1;

FIG. 3 is a view showing an example of IPsec SA entry held by a server of FIG. 1;

FIG. 4 is a flowchart showing the operation of the server when an IP packet occurs; and

FIG. 5 is a flowchart showing the operation of the server of FIG. 1 when a timer starts.

### DESCRIPTION OF THE PREFERRED EMBODIMENTS

An embodiment of the present invention will be described with reference to the drawings.

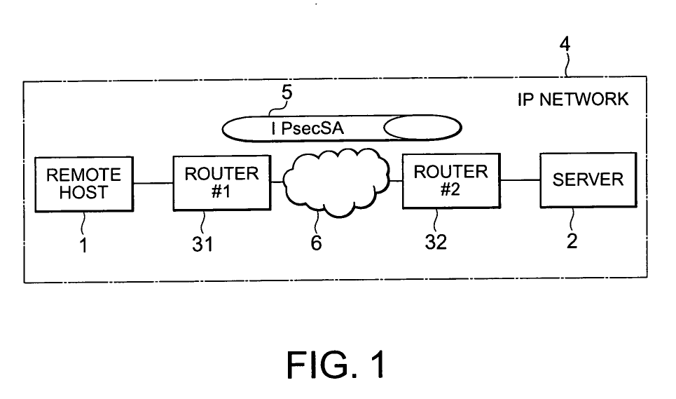

A remote access system in an IP (Internet Protocol) network is composed of a server and a remote host, and routers may exist therein. FIG. 1 is a view showing the arrangement of the remote access system in the IP network according to the embodiment of the present invention. The IP network 4 in the embodiment of the present invention includes the remote host 1, the server 2, and the router (#1) 31 and the router (#2) 32.

The server 2 provides a service and data to the remote host 1 on IP. The routers 31 and 32 read a destination IP address from the header information of an IP packet received thereby and forward an IP packet to the destination IP address according to a routing table (not shown) held thereby.

IPsec (Security Architecture for Internet Protocol) is used in a network (network 6 between the routers 31 and 32) between nodes in which a worry of assault and electrical interception may exist and provides security in the level of a network layer level by encryption and authentication functions. To perform IP communication between nodes, a logical connection called IPsec SA (Security Association) must be established between the nodes. Since IPsec SA has directionality, up SA and down SA are necessary to realize a bidirectional IP communication between two nodes. In the embodiment, as shown in FIG. 1, IPsec SA 5 is established between the routers 31 and 32 which are IPsec terminal nodes each using IPsec as a terminal, respectively. The server 2 communicates with the remote host 1 through the IPsec SA 5 between the routers 31 and 32 and determines whether or not the SA 5 is to be deleted according to the amount of traffics on the SA 5.

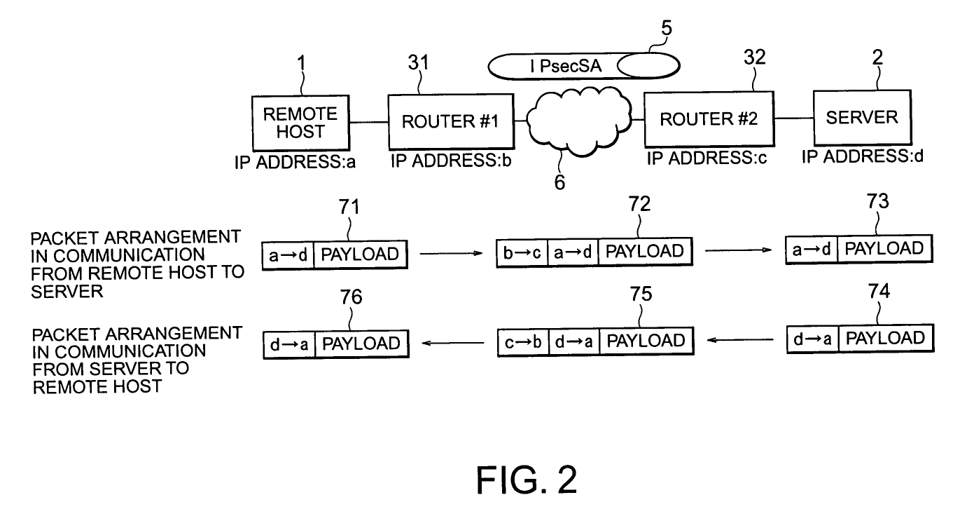

FIG. 2 is a view showing a transition example of an IP packet arrangement when IPsec communication is performed in the system shown in FIG. 1, and the same components as those in FIG. 1 are denoted by the same reference numerals. In FIG. 2, “a →d” in the packet arrangement means that an IP header having a transmission source address shown by “a” and a destination address “d” is added.

In communication from the remote host 1 to the server 2, first, the remote host 1 transmits an IP packet 71 having a header added thereto, the header designating the IP address “d” of the server 2 as a destination address and the IP address “a” of the remote host 1 itself as a transmission source address. Since the remote host 1 knows that the packet addressed to “d” must be transmitted first to an IP address “b”, it transmits the IP packet 71 to the router 31 having the IP address “b”.

Since the router 31 as the IPsec terminal node knows that the packet addressed to “a→d” must pass through the IPsec SA 5, router 31 encapsules the IP packet 71 with the header addressed to the IP address “c” of the router 32 as the other IPsec terminal node, and, as a result, the router 31 transmits a packet 72. In contrast, since the router 32, which has received the packet 72 addressed to “b→c” knows that the packet 72 has passed through the IPsec SA 5, the router 32 decapsules the packet 72 having a “b→c” header added thereto, and, as a result, the router 32 transmits a packet 73 to the address “d”.

In communication from the server 2 to the remote host 1, first, the server 2 transmits an IP packet 74 having a header added thereto, the header designating the IP address “a” of the remote host 1 as a destination address and the IP address “d” of the server 2 itself as a transmission source address. Since the server 2 knows that the packet addressed to “a” must be transmitted to an IP address “c” first, it transmits the IP packet 74 to the router 32 having the IP address “c”.

Since the router 32 as the IPsec terminal node knows that the packet addressed to “d→a” must pass through the IPsec SA 5, it encapsules the IP packet 74 with the header addressed to the IP address “b” of the router 31 as the other IPsec terminal node, and, as a result, the router 32 transmits a packet 75. In contrast, since the router 31, which has received the packet 75 addressed to “c→b” knows that the packet 75 has passed through the IPsec SA 5, the router 31 decapsules the packet 75 to which the “c→b” header is added, and, as a result, the router 31 transmits a packet 76 to the address “a”. As described above, the communication can be performed through the IPsec SA 5 by performing the encapsuling and the decapsuling as described above.

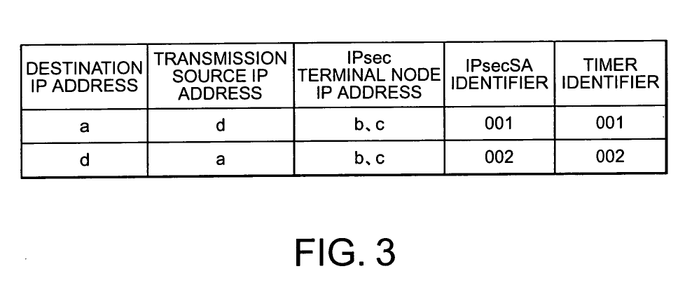

The server 2 determines whether or not the SA 5 is to be deleted according to the amount of traffics on the SA 5. As shown in FIG. 3, the server 2 previously includes an IPsec SA entry having information recorded thereto in order to determine whether or not a packet transmitted from and received by server 2 passes through the IPsec SA 5.

In FIG. 3, an IPsec SA identifier 001 shows IPsec SA 5 (hereinafter, referred to as down SA) in the direction from the router 32 to the router 31, and an IPsec SA identifier 002 shows IPsec SA 5 (hereinafter, referred to as up SA) in the direction from the router 31 to the router 32.

When, for example, a transmission packet to which the header “d→a” is added is generated, the server 2 can determine from the IPsec SA entry that the packet passes through the down SA of the IPsec SA identifier 001 and thus can recognize that a traffic occurs in the down SA. Further, when the server 2 receives, for example, a packet to which the header “a→d” is added, the server 2 can determine from the IPsec SA entry that the packet reaches it passing through the up SA of the IPsec SA identifier 002 and thus can recognize that a traffic occurs in the up SA.

Further, the server 2 has a not shown timer corresponding to each of the IPsec SAs of the IPsec SA identifier in the entry and has the identifiers of the respective timers in the entry to start a timer corresponding SA in which a traffic occurs. Further, the IPsec SA entry has the IP address of a node for terminating corresponding IPsec SA, in addition to the IPsec SA identifier, the destination IP address, the transmission source address, and the timer identifiers.

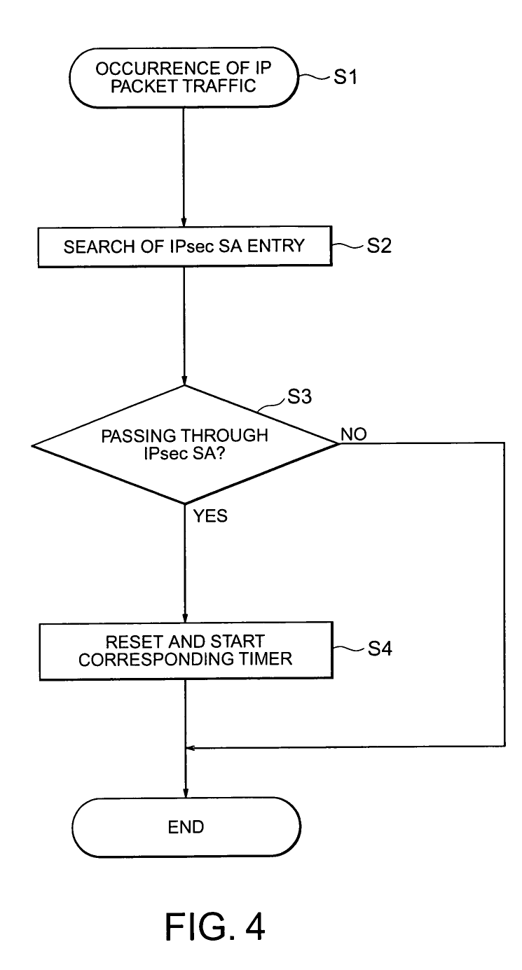

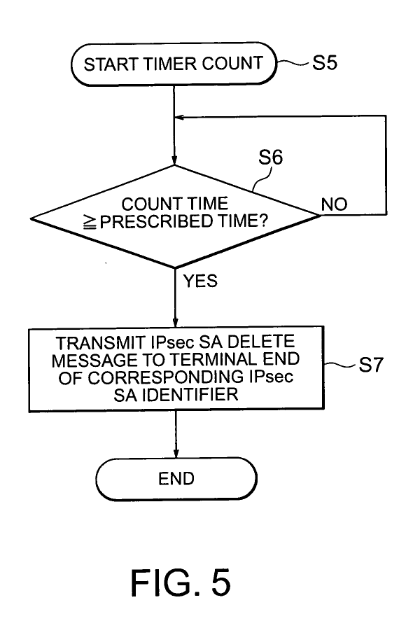

Next, the operation of the server 2 according to the embodiment of the present invention will be described with reference to the drawings. FIG. 4 is a flowchart showing the operation of the server 2 when an IP packet occurs, and FIG. 5 is a flowchart showing the operation of the server 2 when a timer is started.

As shown in FIG. 4, the server 2 receives or transmits the IP packet, and when it is found that an IP traffic occurs (step S1), the server 2 searches the IPsec SA entry based on the destination of the IP packet and the IP address of a transmission source to determine whether or not the IP packet passes through the IPsec SA 5 (up or down SA, step S2). When it is determined that the IP packet passes through the up or down SA (step S3: Yes), the server 2 resets and starts a timer corresponding to the SA (Step S4).

As shown in FIG. 5, when the timer is started (step S5), a time is measured, and when the timer is not reset again at step S4 until a prescribed time is reached (step S 6: Yes), a massage is transmitted to the terminal node of IP packet to request the delete of the IPsec SA(step S6). On receiving the message, the terminal node deletes the IPsec SA.

When, for example, the destination address and the transmission source address of the IP packet occurred at step S1 are “a” and “d”, respectively, it is determined by the IPsec SA entry that the IP packet is transmitted to the remote host 1 through the down SA of the IPsec SA identifier 001 (step S3, Yes), and the server 2 starts the timer of the IPsec SA identifier 001 after it resets the timer. When the time measured by the timer of the IPsec SA identifier 001 reaches a prescribed time without the occurrence of an IP packet having a destination address “a” and a transmission source address “d” in the server 2 (step S6: Yes), the server 2 transmits a message to the routers 31 and 32 as the terminal nodes of the down SA to request to delete the SA (step S6).

Note that the server may transmit the message requesting the delete to one of the routers 31 and 32 as the terminal nodes in place of transmitting it to both of them. In this case, the terminal node having received the delete request message may delete the SA and notify of it to the other terminal node.

It is needless to say that processing operations according to the respective flowcharts shown in FIGS. 4 and 5 can be realized by causing a computer acting as a CPU (controller) to read and perform a program previously stored in a ROM and the like.

As described above, in the embodiment of the present invention, the server 2 determines whether or not the IPsec SA is to be deleted according to the amount of traffics on the IPsec SA by monitoring the traffics on the IPsec SA using the IPsec SA entry. Since it is possible to delete the IPsec SA which is still established regardless that no traffic exists without the need that the routers 31 and 32 as the IPsec terminal nodes determine whether or not the SA is to be deleted, the load of the terminal nodes can be reduced.

Further, since the SA, in which no traffic occurs for the prescribed time, is deleted regardless of the presence or absence of the IPsec terminal node, the number of the IPsec SAs established by the IPsec terminal nodes can be suppressed. With the above arrangement, the resources, which are necessary to maintain the IPsec SA in the IPsec terminal nodes, can be reduced as well as a time necessary to search the IPsec SA can be reduced.

In the embodiment of the present invention, the server 2 transmits the message requesting to delete the IPsec SA by monitoring the traffics on the IPsec SA to thereby suppress the number of the SAs in the IPsec terminal nodes. However, when other nodes are provided with the IPsec SA entry in addition to the server so that they can recognize the traffics of the IPsec SA, this control can be realized. Further, the IPsec SA is used as a subject in the embodiment of the present invention, the subject is not limited thereto, and SA used in other protocol having a function for creating or managing the SA (Internet Security Association & Key Management Protcol) can be also used as the subject. Further, the IPsec SA entry of the server 2 may be notified fro other node.

1. A system for performing communication between first and second nodes disposed on a communication network by establishing SA (Security Association) as a logical connection therebetween, comprising:
a third node for performing communication with an opponent node through the SA disposed on the communication network,
wherein the third node determines according to the amount of traffics on the SA whether or not the SA is to be deleted.

2. The system claimed in claim 1, wherein when no traffic exists on the SA for a predetermined time, the third node transmits a message for requesting to delete the SA to at least one of the first and second nodes.

3. The system claimed in claim 1, wherein the third node previously stores information including the destination addresses and transmission source addresses of data to be transmitted through the SA and determines according to the information whether or not data that the third node sends/receives pass through the SA.

4. A communication node apparatus disposed on a communication network including first and second nodes for performing communication through SA (Security Association) established as a logical connection between the first and second nodes, wherein the apparatus determines according to the amount of traffics on the SA whether or not the SA is to be deleted.

5. The communication node apparatus claimed in claim 4, transmitting a message for requesting to delete the SA to at least one of the first and second nodes when no traffic exists on the SA for a predetermined time

6. The communication node apparatus claimed in claim 4, wherein the apparatus previously stores information including the destination addresses and transmission source addresses of data to be transmitted and received through the SA and determines according to the information whether or not data that the apparatus sends/receives pass through the SA.

7. An operation control method of a communication node apparatus disposed on a communication network including first and second nodes for performing communication through SA (Security Association) established as a logical connection between the first and second nodes comprising the step of:
determining by the apparatus according to the amount of traffics on the SA whether or not the SA is to be deleted.

8. The operation control method claimed in claim 7, wherein when no traffic exists on the SA for a predetermined time, a message for requesting to delete the SA is transmitted from the apparatus to at least one of the first and second communication nodes at the step.

9. The operation control method claimed in claim 7, wherein the communication node apparatus previously stores information including the destination addresses and transmission source addresses of data to be transmitted through the SA and determines according to the information whether or not data that the apparatus sends/receives pass through the SA.

10. A program for causing a computer to perform an operation control method of a communication node apparatus disposed on a communication network including first and second nodes for performing communication by establishing SA (Security Association) as a logical connection between the first and second node and performing the communication through the SA comprising the step of determining by the apparatus according to the amount of traffics on the SA whether or not the SA is to be deleted.

11. A communication node apparatus for performing communication by establishing an SA (Security Association) as a logical connection with a first node, wherein:
the apparatus deletes the SA when receiving a signal from a second node different from the first node; and
the second node generates the signal according to the amount of traffics on the SA.
